(19) United States
(12) Patent Application Publication
(10) Pub. No.: US 2008/0283379 A1
(43) Pub. Date: Nov. 20, 2008

(54) Coaxial switch with reduced tribo-electric charge accumulation

(75) Inventor: An Dan Trinh, Orange, CA (US)

Correspondence Address: K&L GATES LLP, 535 SMITHFIELD STREET, PITTSBURGH, PA, 15222, US

(73) Assignee: Teledyne Technologies Incorporated

(21) Appl. No.: 11/804,618

(22) Filed: May 18, 2007

(51) Int. Cl. H01H 1/12; H01R 9/05

(52) U.S. Cl. 200/504; 361/822

(57) ABSTRACT

A contact carrier, a coaxial switch, and a method of forming the contact carrier are disclosed. A contact carrier includes a body formed of an electrically insulative material. The body includes a longitudinally extending shaft portion and a stem portion. At least one conductive layer is formed on the body.

### BACKGROUND

The present disclosure is directed generally to coaxial switches.

Coaxial switches are employed in modem electronic test equipment. These coaxial switches include insulated or dielectric contact carriers that are actuated to direct incoming signals to different receiving and transmitting paths with an extremely high degree of signal fidelity. As the coaxial switch is actuated multiple times, however, the insulated contact carriers frictionally engage metallic electrically conductive components or elements of the coaxial switch body. The insulated contact carrier acts as a dielectric and static charge, known as tribo-electric charge, accumulates and stores on the dielectric until a discharge level is reached. The tribo-electric discharge usually occurs in the signal path. A tribo-electric discharge through the signal path is undesirable because it may cause false triggering in digital circuits and may jeopardize the signal fidelity.

FIGS. 1A, B illustrate a conventional coaxial switch 100. FIG. 1A shows the coaxial switch 100 in the “OFF” or non-conductive state and FIG. 1B shows the switch in the “ON” or conductive state. FIG. 1A illustrates a conventional coaxial switch 100. The coaxial switch 100 includes a contact carrier 102 formed of dielectric material 104. The contact carrier 102 includes a bearing surface 106 that frictionally engages a metal radio frequency (RF) body 108. The contact carrier 102 also engages a conductive reed 110. A spring 112 is located between a head portion 114 of the contact carrier 102 and a first surface 118a of the metal RF body 108 to maintain electrical contact between the a second surface 118b of the metal RF body 108 and the a first surface 120a of the conductive reed 110. The spring 112 applies a force to the contact carrier 102 in direction B to maintain electrical contact between the first surface 120a of the conductive reed 110 and the second surface 1 18b of the metal RF body 108. As illustrated in FIG. 1B, the electrical contact between the first surface 120a of the conductive reed 110 and the second surface 118b of the metal RF body 108 is broken when a force is applied to the head portion 114 of the contact carrier 102 in direction A. Thus there is an air gap 122 between the second surface 118b of the metal RF body 108 and the first surface 120a of the conductive reed 110.

As the coaxial switch 100 is actuated, the contact carrier 102 moves in direction A and B. The coaxial switch 100 may be employed in modem electronic test equipment. The coaxial switch 100 may be actuated multiple times to direct incoming signals coupled to the metal RF body 108 to different receiving paths coupled by the conductive reed 110 with an extremely high degree of signal fidelity. As the coaxial switch 100 is actuated, however, the bearing surface 106 of the contact carrier 102 frictionally engages the inner metallic surface 124 of the electrically conductive metal RF body 108. Tribo-electric charge is created by the friction between the inner surface 124 of the metal RF body 108 and the bearing surface 106 dielectric 104 material of the insulated contact carrier 102. The tribo-electric charge accumulates and is stored in the dielectric 104 material until a discharge level is reached. As previously discussed, a tribo-electric discharge through signal path C is undesirable because it causes false triggering in digital circuits and also greatly jeopardizes the signal fidelity.

Accordingly, there is a need for a coaxial switch that eliminates or minimizes tribo-electric charge accumulation in the contact carrier. Furthermore, there is a need for a high frequency coaxial switch that eliminates or minimizes tribo-electric discharge in the signal path.

### SUMMARY

In one embodiment, a contact carrier comprises a body formed of an electrically insulative material. The body comprises a longitudinally extending shaft portion and a stem portion. At least one conductive layer is formed on the body.

### BRIEF DESCRIPTION OF THE DRAWINGS

FIGS. 1A, B illustrate a conventional coaxial switch. FIG. 1A shows the switch in the “ON” conductive state and FIG. 1B shows the switch in the “OFF” non-conductive state.

FIG. 2A is a cross sectional view of one embodiment of a dielectric contact carrier comprising a metallized conductive layer.

FIG. 2B is an enlargement of a metallized region of the dielectric contact carrier shown in FIG. 2A.

FIG. 3 is a cross sectional view of one embodiment of a coaxial switch comprising one embodiment of the dielectric contact carrier comprising a metallized conductive layer shown in FIG. 2A.

FIGS. 4A, B are graphs showing tribo electric discharge measurements of conventional coaxial switches such as those illustrated in FIGS. 1A, B.

FIG. 4C is a graph showing tribo electric discharge measurement of one embodiment of a coaxial switch such as the coaxial switch illustrated in FIG. 3.

FIG. 4D is a graph showing the graph illustrated in FIG. 4C magnified by a factor of ten (10×).

### DESCRIPTION

In one general respect, the embodiments described herein are directed to a coaxial switch that eliminates or minimizes tribo-electric charge accumulation in the contact carrier and/or eliminates or minimizes tribo-electric discharge in the signal path. In other general respects, the embodiments described herein are directed to a high frequency coaxial switch that eliminates or minimizes tribo-electric charge accumulation in the contact carrier and/or eliminates or minimizes tribo-electric discharge in the signal path. In one embodiment, a coaxial switch reduces the generation of charge on a component bearing surface during switch actuation. In another embodiment, the coaxial switch provides an instantaneous ground discharge path. In one embodiment, a conductive layer may be formed over the bearing surface of a dielectric carrier for a conductive reed, generally referred to a contact carrier or a dielectric contact carrier. The conductive layer formed over the dielectric material reduces and minimizes tribo-electric charge accumulation in the dielectric and therefore, eliminates or minimizes tribo-electric discharge. Although a relatively small tribo-electric charge may be created from metal to metal surface friction, the amount of charge is much less than the tribo-electric charge created by dielectric to metal surface friction. In addition, the conductive property of the conductive layer formed over the dielectric contact carrier allows tribe-electric charges to dissipate to ground at each actuation of the switch. Thus, further minimizing the accumulation of tribo-electric charge due to repeated and multiple actuations of the contact carrier.

Accordingly, in one embodiment, a coaxial switch comprises a dielectric contact carrier comprising a conductive layer that is selectively metallized in a first region to reduce charge generation and provide a ground dissipation path. The unmetallized region of the dielectric contact carrier performs the conventional contact carrier function with minimal disturbance in mechanical functionality and electrical performance. Any suitable metallization process may be employed to form the conductive layer on the friction bearing surface of the contact carrier body. For example, the conductive layer may be formed by one or more processes including plating, electro-plating, vacuum depositing, evaporating, sputtering, other generally well-known metallization techniques.

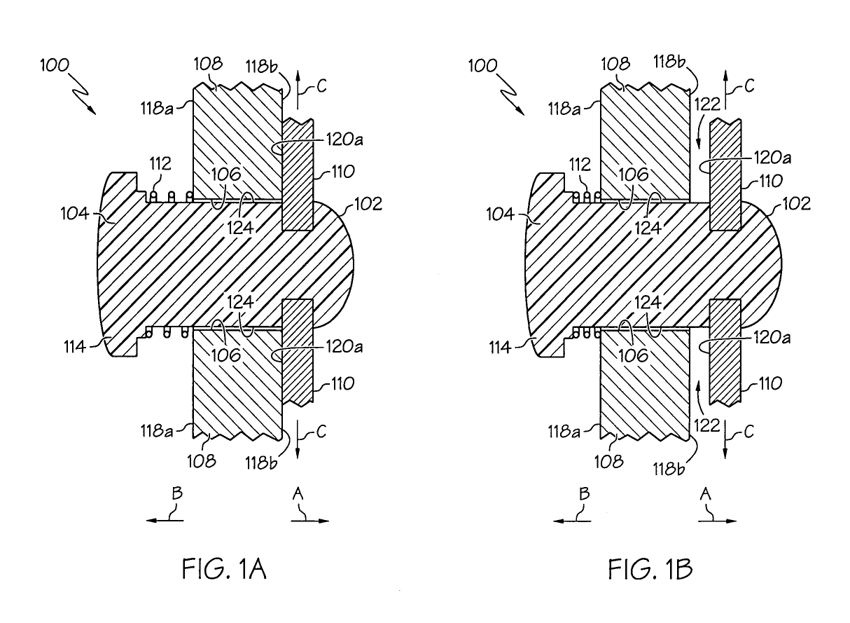

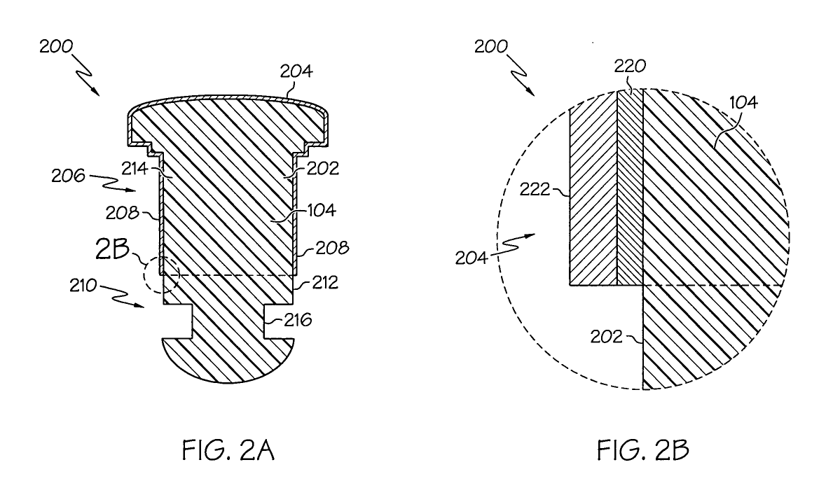

FIG. 2A is a cross sectional view of one embodiment of a dielectric contact carrier 200 comprising a metallized conductive layer. The contact carrier 200 may be employed in a coaxial switch for routing or directing signals. The contact carrier 200 comprises a contact carrier body 202 having a shaft 214 extending longitudinally and a stem 216 to receive the contact reed 110 (FIGS. 1A, B and 3). The contact carrier body 202 comprises a metallized conductive layer 204 formed over an electrically insulative material such as the dielectric 104. The metallized conductive layer 204 may be formed over a first region 206. The metallized conductive layer 204 may be formed either overt the entire bearing surface 208 of the contact carrier body 202 or a portion of the contact carrier body 202. In the illustrated embodiment, the metallized conductive layer 204 is formed over the first region and is not formed over a surface 212 of a second region 210 of the contact carrier body 202 and it remains unmetallized. The selectively metallized first region 206 comprising the metallized conductive layer 204 greatly reduces, minimizes, or eliminates charge generation and accumulation, and provides a dissipation path to ground to further reduce, minimize, or eliminate charge accumulation due to repeated activations of the contact carrier 200. The unmetallized second region 210 of the dielectric contact carrier body 202 performs the conventional function of the contact carrier body 202 with minimal disturbance in mechanical functionality and electrical performance. The embodiments, however, are not limited in this context.

FIG. 2B is an enlargement of the metallized and non-metallized regions of the dielectric contact carrier 200 shown in FIG. 2A. In one embodiment, the metallized conductive layer 204 of the contact carrier body 202 may comprise multiple layers of metallic material formed over each other in various thicknesses. In the illustrated embodiment, the metallized conductive layer 204 comprises two metallic layers formed over the dielectric 104 material of the contact carrier body 202. A first layer 220 of a predetermined first thickness may be formed over the dielectric 104 material employing various processes. A second layer 222 of a predetermined second thickness may be formed over the first layer 220. The thickness of the first and second layers 220, 22 thicknesses may be equal or different. In one embodiment, the thickness of the first layer 220 may be at least the thickness of the second layer 222. In another embodiment, the thickness of the second layer 222 may be at least the thickness of the first layer 220. Other suitable thicknesses for the first and second layers 220, 222 may be selected without limitation. In addition, multiple additional layers may be formed without limitation. The embodiments, however, are not limited in this context.

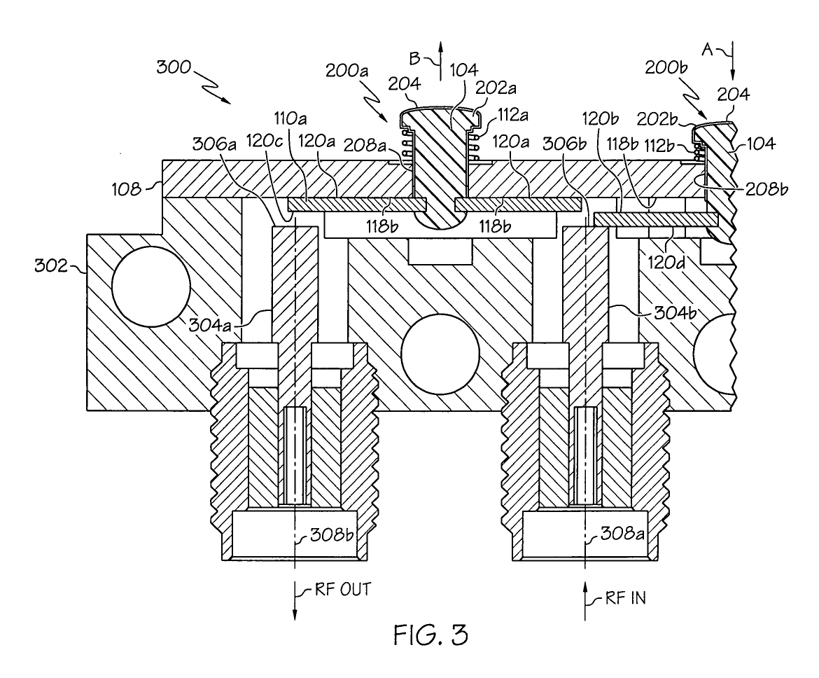

With reference now to both FIGS. 2A and 2B, in one embodiment, the metallized layer 204 may be formed over the first region 206 of the contact carrier body 202 by installing a rubber boot over the surface 212 in the second region. The boot may have a diameter that is smaller than the diameter of the shaft 214 of the contact carrier body 202. The surface 212 that is covered by the boot will not be metallized. The contact carrier 200 and boot assembly is cleaned with a solvent and thoroughly dried. The contact carrier 200 and boot assembly is then plated with a first layer of a first metal. The first metallic layer may be over plated with a second layer of a second metal. In one embodiment, the first metallic layer may be at least as thick as the second metallic layer and in other embodiments the second metallic layer may be at least as thick as the first metallic layer. Additional layers of metals may be formed over the second metallic layer, and so on, as may be suitable for a specific application. Once the metallic layers are formed over the first region 206 of the bearing surface 208, the boot is removed. The contact reed 110 (FIGS. 1A, B, and 3) is staked over the unmetallized stem 216 portion of the contact carrier body 202 prior to being assembled to a coaxial switch 300 (FIG. 3).

In one embodiment, the dielectric 104 may be formed of any suitable dielectric material such as, for example, Polychloro Trifluoro Ethylene. In one embodiment, the first metallic layer may be formed of a micro-inch layer of metal, for example. The first metallic layer may comprise a 50-100 micro-inch layer of the first metal. The first metal may be Nickel, for example. In one embodiment, second metallic layer may be formed of a micro-inch layer of the second metal, for example. The second metallic layer may comprise 100-150 micro-inch layer of the second metal. The second metal may be Gold, for example. In one embodiment, the second metal may be hard Gold. The metallization of the first and second conductive layers 220, 222 may be formed by employing any suitable metallization process to form the first conductive layer 220 over the friction bearing surface of the contact carrier body 202 and forming the second layer 222 over the first layer 220, and so on. For example, the first and second conductive layers 220, 222 may be formed by one or more processes including plating, electro-plating, vacuum depositing, evaporating, sputtering, other generally well-known metallization techniques.

FIG. 3 is a cross sectional view of one embodiment of a coaxial switch 300 comprising one embodiment of the dielectric contact carrier 200 comprising a metallized conductive layer shown in FIG. 2A. In one embodiment, the coaxial switch 300 comprises one or more dielectric contact carriers 200. In the illustrated embodiment, the coaxial switch comprises multiple dielectric contact carriers 200a, 200b, and so forth. The coaxial switch 300 comprises a metallic upper RF body 108 and a metallic lower RF body 302. The upper RF body 108 engages the bearing surface 208 of the contact carrier body 202. In the illustrated embodiment, the upper RF body 108 frictionally engages the bearing surface 208a of the contact carrier body 202a and the bearing surface 208b of the contact carrier body 202b. The second surface 118b of the upper RF body 108 electrically engages the first surfaces 120a and 120b of the respective conductive reeds 110a, 110b, and so forth.

Multiple stationary probes 340a, 304b, and so forth, are engage RF signals. In the illustrated embodiment, the multiple stationary probes 304a, b and the respective conductive reeds 110a, b direct incoming and outgoing RF signals from an input signal path 308a or an output signal path 308b. The RF signals are switched with an extremely high degree of signal fidelity by actuating the plated dielectric contact carriers 200a, b of the coaxial switch 300. The stationary probes 304a, b comprise respective electrical conductive surfaces 306a, and 306b to electrically engage respective surfaces 120c and 120d of the respective conductive reeds 110a, b.

The conductive reeds 110a, b electrically engage and disengage the upper RF body 108 and the respective stationary probes 304a, b by actuating the contact carrier bodies 202a, b. As shown in the illustrated embodiment, the carrier contact body 202a is in the “OFF” position and is maintained in there by the force of the spring 112a in direction B. The first surface 120a of the conductive reed 110a is in electrical contact with the second surface 118b of the upper RF body 108. The second surface 120c of the conductive reed 110a is not in electrical contact with the electrical conductive surface 306a of the stationary probe 304a. Accordingly, the RF OUT signal in the signal path 208b is not coupled by the coaxial switch 300 to external devices.

In the illustrated embodiment, the carrier-contact body 202b is in the “ON” position. The carrier body 202b is actuated applying a force in direction A and compressing the spring 112b. The carrier body 202b remains in the “ON” position until it is actuated once again and it returns to the “OFF” position by the spring 112b acting in direction B. The first surface 120b of the conductive reed 110b is not in electrical contact with the second surface 118b of the upper RF body 108. The second surface 120d of the conductive reed 110b is in electrical contact with the electrical conductive surface 306b of the stationary probe 304b. Accordingly, the RF IN signal in the signal path 208a from external devices is coupled by the coaxial switch 300 through the conductive reed 110b.

Each of the carrier contact bodies 202a, b of the dielectric contact carriers 200a, 200b comprise the metallized layer 204. Accordingly, as the bearing surfaces 208a, b of the respective contact carrier bodies 202a, b are repeatedly actuated, the charge accumulated in the dielectric 104 material is minimized because of the metal to metal friction between the metallized conductive layer 204 and the upper RF body 108. Thus, any tribo-electric charge created by metal to metal surface friction by the metallized conductive layer 204 and the upper RF body 108 is much less than the tribo-electric charge created by dielectric to metal surface friction in conventional coaxial switches (e.g., coaxial switch 100 illustrated in FIGS. 1A, B). Furthermore, if the upper RF body 108 is electrically coupled to ground, the conductive property of the contact carrier bodies 202a, b comprising the metallized dielectric contact layers 204 allows tribe-electric charges to dissipate to ground at each actuation of the dielectric contact carriers 200a, 200b of the switch 300.

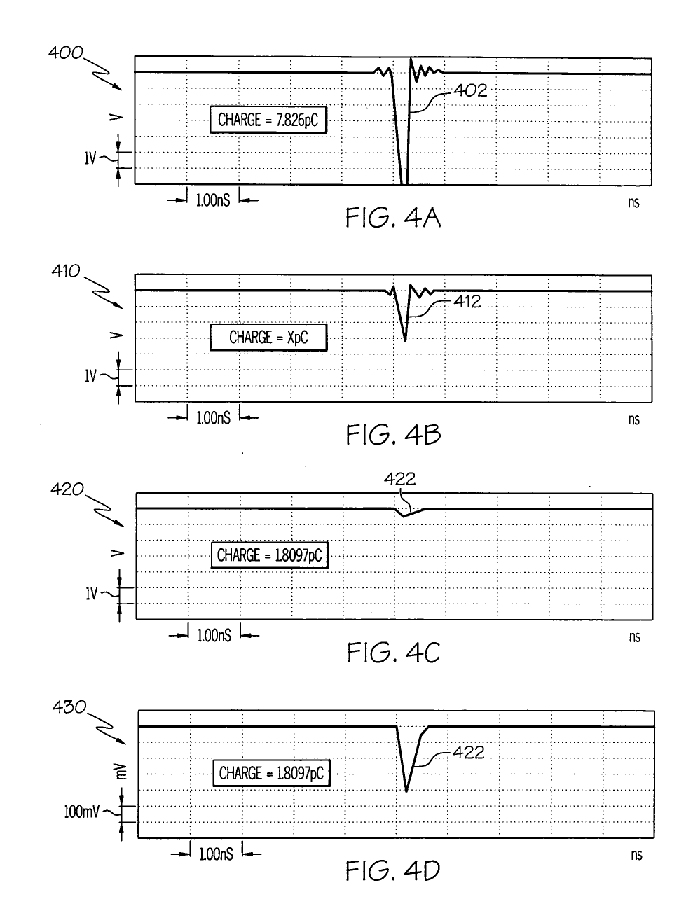

FIGS. 4A, B are graphs 400, 410, respectively, showing tribo electric discharge measurements of conventional coaxial switches such as those illustrated in FIGS. 1A, B. FIG. 4C is a graph 420 showing tribo electric discharge measurement of one embodiment of a coaxial switch such as the coaxial switch 300 illustrated in FIG. 3. FIG. 4D is a graph 430 showing the graph 420 illustrated in FIG. 4C magnified by a factor of ten (10×). The graphs 400, 410, 420, 430 represent the discharge of tribo-electric charge accumulated on the dielectric contact carrier 200 though the coaxial switch 300. The vertical scale for the graphs 400, 410, and 430 is 1V/Div. The vertical scale for the graph 430 is 100 mV/Div. The horizontal scale for the graphs 400, 410, 420, and 430 is 1.00 nS/Div.

As shown in FIG. 4A, the graph 400 exhibits a discharge voltage transient 402 in the negative vertical direction that may be generated by the conventional coaxial switch 100. The discharge voltage transient 402 is large enough to be off the measurement scale and is substantially unmeasurable. The discharge voltage transient 402 represents a discharge over time of a tribo electric charge accumulated on the contact carrier 102 of the coaxial switch 100. As illustrated in FIG. 4A, the discharge voltage transient 402 represents a charge of 7.826 pC (pico Coulombs). With respect to the graph 400, the discharge voltage transient 402 occurred after only three activations of the coaxial switch 100. Similarly, in FIG. 4B, the graph 410 exhibits a discharge voltage transient 412 in the negative vertical direction that may be generated by a conventional coaxial switch similar to the conventional coaxial switch 100. The discharge voltage transient 412 is over 3V. The discharge voltage transient 412 represents a discharge over time of a tribo electric charge accumulated on a contact carrier of a coaxial switch of XpC.

As shown in FIG. 4C and amplified by a factor of 10 (10×) in FIG. 4D, the graphs 420 and 430 exhibit a discharge voltage transient 422 for the coaxial switch 300 in the negative vertical direction of less than one-half of one volt (<½ V). The discharge voltage transient 422 represents a discharge over time of a tribo-electric charge accumulated on the contact carrier 200 of the coaxial switch 300. The discharge voltage transient 422 represents a charge of less than 2 pC, and in the illustrated embodiment, represents a charge of about 1.8097 pC. As can be seen from the graphs 420 and 430, the coaxial switch 300 with the contact carrier 200 comprising the metallized layer 204 formed over the dielectric 104, shown improved tribo-electric discharge voltage transient 422 levels over the tribo-electric discharge voltage 402, 412 levels shown in graphs 400 and 410.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. A contact carrier, comprising:
a body formed of an electrically insulative material, the body comprising:
a longitudinally extending shaft portion;
a stem portion; and
at least one conductive layer formed on the body.

2. The contact carrier of claim 1, comprising:
a first conductive layer formed on the body; and
at least a second conductive layer formed on the first conductive layer.

3. The contact carrier of claim 2, wherein the first conductive layer has a thickness at least that of the second conductive layer.

4. The contact carrier of claim 2, wherein the second conductive layer has a thickness at least that of the first conductive layer.

5. The contact carrier of claim 2, wherein the first conductive layer has a thickness equal to that of the second conductive layer.

6. The contact carrier of claim 2, wherein the first conductive layer comprises a 50-100 micro-inch layer of a first metal; and
wherein the second conductive layer comprises a 100-150 micro-inch layer of a second metal.

7. The contact carrier of claim 1, wherein the at least one conductive layer is formed on the longitudinally extending shaft portion of the body.

8. The contact carrier of claim 1, wherein the at least one conductive layer is not formed on the stem portion of the body.

9. The contact carrier of claim 1, wherein the electrically insulative material comprises a dielectric material.

10. A coaxial switch, comprising:
a first contact carrier comprising a body formed of an electrically insulative material, the body comprising a longitudinally extending shaft portion; a stem portion; and at least one conductive layer formed on the body; and
a first conductive reed coupled to the stem portion.

11. The coaxial switch of claim 10, wherein the first contact carrier comprises a first conductive layer formed on the body; and at least a second conductive layer formed on the first conductive layer.

12. The coaxial switch of claim 11, wherein the first conductive layer has a thickness at least that of the second conductive layer.

13. The coaxial switch of claim 11, wherein the second conductive layer has a thickness at least that of the first conductive layer.

14. The coaxial switch of claim 11, wherein the first conductive layer has a thickness equal to that of the second conductive layer.

15. The coaxial switch of claim 11, wherein the first conductive layer comprises a 50-100 micro-inch layer of a first metal; and
wherein the second conductive layer comprises a 100-150 micro-inch layer of a second metal.

16. The coaxial switch of claim 10, wherein the at least one conductive layer is formed on the longitudinally extending shaft portion of the body.

17. The coaxial switch of claim 10, wherein the at least one conductive layer is not formed on the stem portion of the body.

18. The coaxial switch of claim 10, wherein the electrically insulative material comprises a dielectric material.

19. The coaxial switch of claim 10, comprising:
a second contact carrier comprising a body formed of an electrically insulative material, the body comprising a longitudinally extending shaft portion; a stem portion; and at least one conductive layer formed on the body; and
a second conductive reed coupled to the stem portion.

20. A method comprising:
forming at least a first conductive layer on a longitudinally extending shaft portion of a contact carrier body formed of an electrically insulative material.

21. The method of claim 20, comprising:
forming at least a second conductive layer on the fist conductive layer.
